(19) United States
(12) Patent Application Publication
(10) Pub. No.: US 2009/0177690 A1
(43) Pub. Date: Jul. 9, 2009

(54) Determining an Optimal Solution Set Based on Human Selection

(76) Inventors: Sinem Guven, New York, NY (US); Gopal Sarma Pingali, Mohegan Lake, NY (US); Debanjan Saha, Mohegan Lake, NY (US); Ramendra Kumar Sahoo, Mohegan Lake, NY (US); Anees Shaikh, Yorktown Heights, NY (US)

Correspondence Address: RYAN, MASON & LEWIS, LLP, 90 FOREST AVENUE, LOCUST VALLEY, NY, 11560, US

(21) Appl. No.: 11/968,993

(22) Filed: Jan. 3, 2008

(51) Int. Cl. G06F 17/30

(52) U.S. Cl. 707/104.1; 707/E17.009

(57) ABSTRACT

An exemplary method of determining a set of optimal solutions for a problem includes the steps of determining a set of probable solutions for the problem; presenting the set of probable solutions to at least one human expert; receiving at least one selection by the at least one human expert of at least one solution from the set of probable solutions; and determining a set of optimal solutions from the set of probable solutions based at least in part on the at least one selection by the at least one human expert. The method may also include steps of presenting at least one of the set of probable solutions and the set of optimal solutions to at least another human expert; permitting the at least another human expert to select at least one solution from at least one of the set of probable solutions and the set of optimal solutions; and determining a set of optimal solutions from the set of probable solutions based at least in part on the at least one selection by the at least one human expert and the at least one selection by the at least another human expert.

### FIELD OF THE INVENTION

The present invention relates generally to electrical, electronic and computer arts, and more particularly relates to techniques for optimizing a solution set.

### BACKGROUND OF THE INVENTION

Support for consumer and commercial products is often provided telephonically. In such situations, an operator (often referred to as a “helpdesk” operator) receives a telephone call with a problem. The telephone operator assigns each problem a specific identification code and records the user's problem (and the help advice provided) in a computerized file. In such a system, if the user calls back, other helpdesk operators can retrieve the computerized file using the specific identification code. This prevents the user from having to wait to speak with a specific helpdesk operator. Additionally, this system provides a helpdesk data set of problems and corresponding solutions which other helpdesk operators can access when offering potential solutions to users.

Free-form computer helpdesk data sets consist primarily of short text descriptions, also known as “unstructured,”, “descriptive,” or “narrative” elements, composed by helpdesk operator(s) for the purpose of summarizing what problem a user had and what was done by any helpdesk operator or technical or non-technical administration professionals to solve that problem. A typical text document (known as a problem ticket) from this data consists of a series of exchanges between an end user and the helpdesk operator.

Problem tickets may include only a single symptom and resolution pair or the problem tickets may span multiple questions, symptoms, answers, attempted fixes, and resolutions, all pertaining to the same basic issue. Problem tickets are opened when the user makes the first call to the helpdesk and closed when all user problems documented in the first call are finally resolved in some way. Helpdesk operators enter problem tickets directly into the database.

For example, one problem ticket may read as follows: “1836853 User calling in with WORD BASIC error when opening files in word. Had user delete NORMAL.DOT and had the user reenter Word, the user was fine at that point. 00:04:17 ducar May 2:07:05:656 P.” This exemplary problem ticket begins with the unique identification number, which is followed by a brief identification of the user's problem, the solution offered, the helpdesk operators name or identification symbol, and a date and time stamp.

Unfortunately, however, problem tickets often lack detailed solutions steps. This is usually because helpdesk operators are typically in a rush to close the tickets as soon as possible and move on to other tickets. Other contributing factors to this absence of detailed solution steps within problem ticket records may include an absence of a proper solution reporting structure within the problem ticket records; the fact that helpdesk operators are sometimes not required to report solution details before moving to next set of problems; and the fact that reporting of problem solutions in detail would require helpdesk operators to develop comprehensive solution steps and may require several hours of work not related to direct customer benefits. Moreover, the people closing the problems may not be different from the people who actually have gone through and solved the bulk of the problem. For example, sometimes a particular problem is solved by many helpdesk operators at different escalation levels using many trial and error methods which are not suitable to be part of a solution profile within a problem ticket database. As a result, even if solution steps are available within the problem ticket database, many of the records are almost unusable in the future or contain information which would be too difficult to identify and work towards close-form solutions through global searches.

Accordingly, there exists a need for improved techniques for determining an optimal solution set that do not suffer from one or more of the problems exhibited by conventional techniques.

### SUMMARY OF THE INVENTION

An exemplary method of determining a set of optimal solutions for a problem includes the steps of determining a set of probable solutions for the problem; presenting the set of probable solutions to at least one human expert; receiving at least one selection by the at least one human expert of at least one solution from the set of probable solutions; and determining a set of optimal solutions from the set of probable solutions based at least in part on the at least one selection by the at least one human expert. The method may also include steps of presenting at least one of the set of probable solutions and the set of optimal solutions to at least another human expert; permitting the at least another human expert to select at least one solution from at least one of the set of probable solutions and the set of optimal solutions; and determining a set of optimal solutions from the set of probable solutions based at least in part on the at least one selection by the at least one human expert and the at least one selection by the at least another human expert.

Techniques according to embodiments of the present invention permit the incorporation of the knowledge acquired by human experts from years of experience regarding optimal solutions for a given problem while minimizing reporting requirements for these human experts. Moreover, illustrative embodiments of the invention provide top level solution methods used for the problems along with continual updates and/or learning.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a flowchart showing an exemplary method according to a first illustrative embodiment of the present invention.

FIG. 2 shows an exemplary solution set during each step of a first illustrative embodiment of the method shown in FIG. 1.

FIG. 3 shows an exemplary solution set during each step of a second illustrative embodiment of the method shown in FIG. 1.

FIG. 4 shows an exemplary solution set during each step of a third illustrative embodiment of the method shown in FIG. 1.

FIG. 5 is a flowchart showing an exemplary method according to a second illustrative embodiment of the present invention.

FIG. 6 shows an exemplary solution set during each step of a first illustrative embodiment of the method shown in FIG. 5.

FIG. 7 shows an exemplary solution set during each step of a second illustrative embodiment of the method shown in FIG. 5.

FIG. 8 is a flowchart showing an exemplary method according to a third illustrative embodiment of the present invention.

FIG. 9 shows an exemplary solution set during each step of an illustrative embodiment of the method shown in FIG. 8.

FIG. 10 is a block diagram depicting an exemplary processing system in which inventive techniques may be implemented.

### DETAILED DESCRIPTION OF THE INVENTION

The present invention will be described herein in the context of illustrative methodologies for determining an optimal solution set based on human selection. It should be understood, however, that although the present invention is described herein primarily as applied to a helpdesk system, inventive techniques may be applicable to optimization of a solution set within any number of fields.

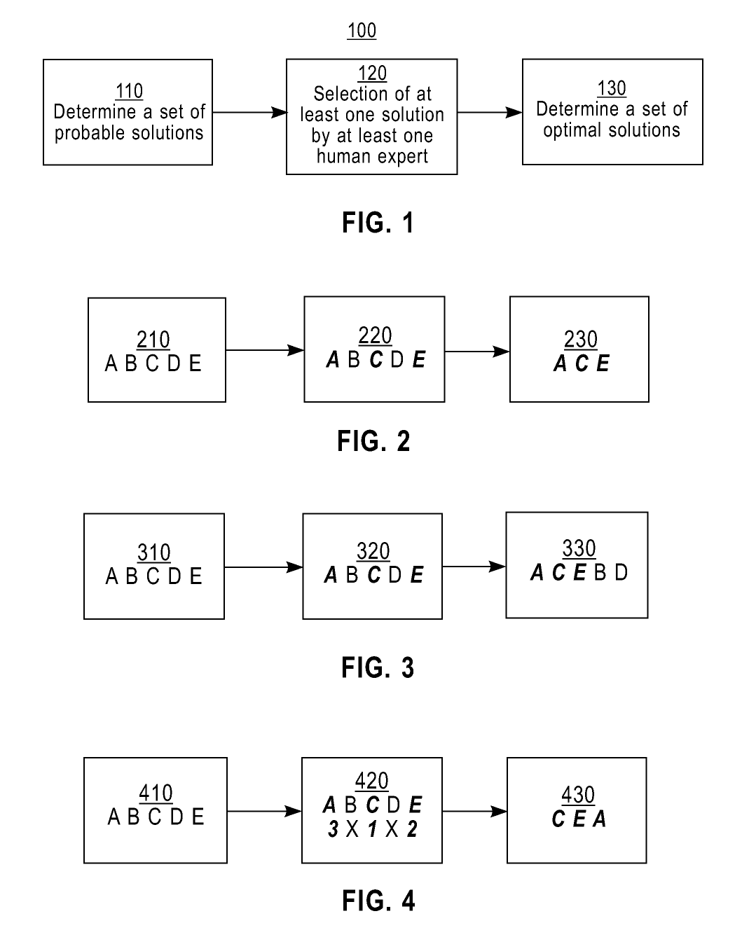

FIG. 1 is a flowchart showing an exemplary method 100 according to a first illustrative embodiment of the present invention. This method begins in step 110 with the determination of a set of probable solutions for a problem. This step of determining a set of probable solutions may comprise automated mining of problem ticket records using conventional techniques such as categorized probes and/or extraction of key phrases. For example, a preferred embodiment may use the techniques disclosed in commonly-assigned U.S. Pat. No. 6,829,734, the disclosure of which is incorporated by reference herein.

This step of determining a set of probable solutions may alternatively or additionally comprise accessing a repository of stored solutions. These stored solutions may comprise at least a portion of an optimal solution set previously determined using a technique according to an illustrative embodiment of the present invention. This step of determining a set of probable solutions may alternatively or additionally comprise manual entry of one or more probable solutions.

Step 120 comprises presenting the set of probable solutions determined in step 110 to at least one human expert and receiving at least one selection by the at least one human expert of at least one solution from the set of probable solutions. This selection could be as simple as a human expert “clicking on” or otherwise designating at least one solution from the set of probable solutions. As will be discussed hereinafter, this selection could also include more complex selections, such as assigning one or more solutions an ordinal ranking (e.g., first choice, second choice, third choice) or a cardinal score (e.g., a scale of 1-10, with 1 being most optimal and 10 being least optimal).

Step 130 comprises determining a set of optimal solutions from the set of probable solutions determined in step 110 based at least in part on the at least one selection by the at least one human expert made in step 120. As will discussed in greater detail hereinafter, this step could comprise, for example, removing at least a portion of the probable solutions not selected by the at least one human expert from the set of probable solutions and/or re-ordering at least a portion of the set of probable solutions.

Optionally, this step may comprise storing the set of optimal solutions in a repository. This may, for example, comprise a local repository. Alternatively or additionally, at least a portion of the set of optimal solutions may be stored within the ticket records themselves. In a preferred embodiment, these stored solutions may be used as a set of probable solutions in a subsequent iteration of the method described above.

FIG. 2 shows an exemplary solution set during each step of a first illustrative embodiment of the method 100 shown in FIG. 1. Specifically, block 210 shows an exemplary set of probable solutions, corresponding to a possible output of step 110 shown in FIG. 1. Letters A-E represent five probable solutions. It should be noted that although this exemplary set comprises five probable solutions, the inventive techniques may be used with any number of probable solutions.

Block 220 shows exemplary selections by a human expert of solutions within the set of probable solutions shown in block 210. These selections correspond to a possible output of step 120 shown in FIG. 1. In this exemplary embodiment, a human expert has selected solutions A, C and E from the set of probable solutions. The selected solutions are indicated through the use of a bold italic font.

Block 230 shows an exemplary set of optimal solutions, corresponding to a possible output of step 130 shown in FIG. 1. In this exemplary embodiment, solutions B and D, which were not selected by the human expert, have been removed from the set of probable solutions. Thus, in this exemplary embodiment, the set of optimal solutions consists of the solutions which were selected by the human expert.

FIG. 3 shows an exemplary solution set during each step of a second illustrative embodiment of the method 100 shown in FIG. 1. Block 310, like block 210, shows an exemplary set of probable solutions, corresponding to a possible output of step 110 shown in FIG. 1. Block 320 shows exemplary selections by a human expert of solutions within the set of probable solutions, corresponding to a possible output of step 120 shown in FIG. 1. In this exemplary embodiment, the human expert has again selected solutions A, C and E from the set of probable solutions.

Block 330 shows an exemplary set of optimal solutions, corresponding to a possible output of step 130 shown in FIG. 1. In this exemplary embodiment, in contrast to that shown in FIG. 2, solutions B and D have not been removed from the set of probable solutions. Instead, the set of probable solutions has been re-ordered to form the set of optimal solutions. More specifically, solutions A, C and E, which were selected by the human expert, have been moved to the front of the set and solutions B and D, which were not selected by the human expert, have been moved to the rear of the set. In a subsequent iteration of the method, solutions at the front of the set of probable solutions are preferably indicated as representative of a higher likelihood of success compared to solutions at the rear of the set.

FIG. 4 shows an exemplary solution set during each step of a third illustrative embodiment of the method 100 shown in FIG. 1. Block 410 again shows an exemplary set of probable solutions, corresponding to a possible output of step 110 shown in FIG. 1. Block 420 shows exemplary selections by a human expert of solutions within the set of probable solutions, corresponding to a possible output of step 120 shown in FIG. 1. In this embodiment, however, each of the selected solutions is assigned a numeric value.

This numeric value may represent either an ordinal ranking (e.g., 1 is most optimal and 3 is least optimal), or a cardinal score (e.g., a scale of 1 to 5, with 1 being most optimal and 5 being least optimal). These values may be explicitly assigned by the expert or they may be assigned based on input from the expert. For example, in a preferred embodiment, the order in which an expert selects solutions is used to determine a ranking, with the first solution selected being assigned the highest ranking, the next solution selected being assigned the next-highest ranking, etc.

In the exemplary embodiment shown here, solution A has been selected by the expert and assigned a value of 3; solution C has been selected by the expert and assigned a value of 1; and solution E has been selected by the expert and assigned a value of 2. Solutions B and D have not been selected by the expert and hence have not been assigned values (represented by “X”).

Block 430 shows an exemplary set of optimal solutions, corresponding to a possible output of step 130 shown in FIG. 1. In this exemplary embodiment, non-selected solutions B and D have been removed from the set of probable solutions. Moreover, solutions A, C and E, which were selected by the human expert, have been re-ordered in accordance with their assigned values. C, which was assigned a value of 1, has been moved to the front of the list and A, which was assigned a value of 3, has been moved to the rear of the list. Thus, the determination of the set of optimal solutions in this embodiment comprises both removal of non-selected solutions and re-ordering of selected solutions.

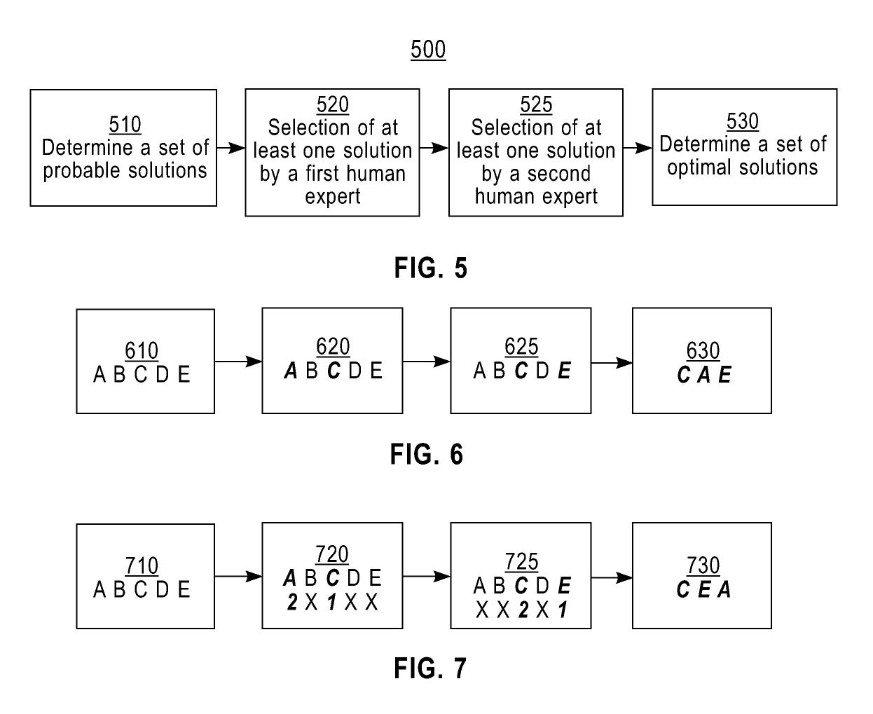

FIG. 5 is a flowchart showing an exemplary method 500 according to a second illustrative embodiment of the present invention. This method begins in step 510 with the determination of a set of probable solutions for a problem. As discussed above in reference to step 110 shown in FIG. 1, this step of determining a set of probable solutions may comprise, for example, automated mining of problem ticket records, accessing a repository of stored solutions, and/or manual entry of one or more probable solutions. Step 520 comprises presenting the set of probable solutions determined in step 510 to at least a first human expert and receiving at least one selection by the at least a first human expert of at least one solution from the set of probable solutions. As discussed above in reference to step 120 shown in FIG. 1, this selection could be as simple as a human expert designating at least one solution from the set of probable solutions or could also include assigning solutions a numeric value, such as an ordinal ranking (e.g., first choice, second choice, third choice) or a cardinal score (e.g., a scale of 1-10, with 1 being most optimal and 10 being least optimal).

Step 525 comprises presenting the set of probable solutions determined in step 510 to at least a second human expert and receiving at least one selection by the at least second human expert of at least one solution from the set of probable solutions. Again, this selection could be as simple as a second human expert designating at least one solution from the set of probable solutions or could also include assigning solutions a numeric value, such as an ordinal ranking (e.g., first choice, second choice, third choice) or a cardinal score (e.g., a scale of 1-10, with 1 being most optimal and 10 being least optimal).

Step 530 comprises determining a set of optimal solutions from the set of probable solutions based at least in part on the at least one selection by the at least first human expert made in step 520 and the at least one selection by the at least second human expert made in step 525. As will discussed in greater detail hereinafter, this step could comprise, for example, removing at least a portion of the probable solutions not selected by one or more of the human experts from the set of probable solutions and/or re-ordering at least a portion of the set of probable solutions. As discussed above with reference to step 130 shown in FIG. 1, this step may optionally comprise storing the set of optimal solutions in a repository which may, for example, comprise a local repository. Alternatively or additionally, at least a portion of the set of optimal solutions may be stored within the ticket records themselves. In a preferred embodiment, these stored solutions may be used as a set of probable solutions in a subsequent iteration of the method described above.

The technique shown in FIG. 5 advantageously permits multiple experts to provide independent selections from the set of probable solutions. Each of these independent selections may play a part in the determination of the set of optimal solutions. For example, the set of optimal solutions may comprise only those solutions selected by all of the human experts, or it may comprise only those solutions selected by one or more of the human experts.

FIG. 6 shows an exemplary solution set during each step of a first illustrative embodiment of the method 500 shown in FIG. 5. Specifically, block 610 shows an exemplary set of probable solutions, corresponding to a possible output of step 510 shown in FIG. 5. Letters A-E represent five probable solutions. It should be noted that although this exemplary set comprises five probable solutions, the inventive techniques may be used with any number of probable solutions.

Block 620 shows exemplary selections by a first human expert of solutions within the set of probable solutions shown in block 610, corresponding to a possible output of step 520 shown in FIG. 5. In this exemplary embodiment, the first human expert has selected solutions A and C from the set of probable solutions. The selected solutions are indicated through the use of a bold italic font.

Block 625 shows exemplary selections by a second human expert of solutions within the set of probable solutions shown in block 610, corresponding to a possible output of step 525 in FIG. 5. In this exemplary embodiment, the second human expert has selected solutions C and E from the set of probable solutions. The selected solutions are indicated through the use of a bold italic font.

Block 630 shows an exemplary set of optimal solutions, corresponding to a possible output of step 530 shown in FIG. 5. In this exemplary embodiment, solutions B and D, which were selected by neither human expert, have been removed from the set of probable solutions. In this example, solution C has been placed at the front of the set because it was selected by both experts. The ordering of solution A before E may be based on a priority that has been granted to the first human expert over the second, or it may be based solely on the original ordering of A before E in the set of probable solutions. Alternative ordering methodologies are similarly contemplated.

FIG. 7 shows an exemplary solution set during each step of a second illustrative embodiment of the method 500 shown in FIG. 5. Block 710 shows an exemplary set of probable solutions, corresponding to a possible output of step 510 shown in FIG. 5.

Block 720 shows exemplary selections by a first human expert of solutions within the set of probable solutions shown in block 710, corresponding to a possible output of step 520 shown in FIG. 5. In this exemplary embodiment, the first human expert has selected solutions A and C from the set of probable solutions. The selected solutions are indicated through the use of a bold italic font. In this embodiment, however, each of the selected solutions is assigned a numeric value, as discussed above with reference to step 420 of FIG. 4. In the exemplary embodiment shown here, solution C has been selected by the first expert and assigned a value of 1. Solution A has been selected by the first expert and assigned a value of 2. Solutions B, D and E have not been selected by the first expert and hence have not been assigned values (represented by “X”).

Block 725 shows exemplary selections by a second human expert of solutions within the set of probable solutions shown in block 710, corresponding to a possible output of step 525 in FIG. 5. In this exemplary embodiment, the second human expert has selected solutions C and E from the set of probable solutions. The selected solutions are indicated through the use of a bold italic font. In this embodiment, however, each of the selected solutions is assigned a numeric value, as discussed above with reference to step 420 of FIG. 4. In the exemplary embodiment shown here, solution C has been selected by the second expert and assigned a value of 2. Solution A has been selected by the second expert and assigned a value of 1. Solutions B, D and E have not been selected by the second expert and hence have not been assigned values (represented by “X”).

Block 730 shows an exemplary set of optimal solutions, corresponding to a possible output of step 530 shown in FIG. 5. In this exemplary embodiment, solutions B and D, which were selected by neither human expert, have been removed from the set of probable solutions. In this example, solution C has been placed at the front of the set because it was selected by both experts. Solution E has been re-ordered before A because solution E was assigned a score of 1 by the one expert who selected solution E, whereas solution A was assigned a score of 2 by the one expert who selected solution A.

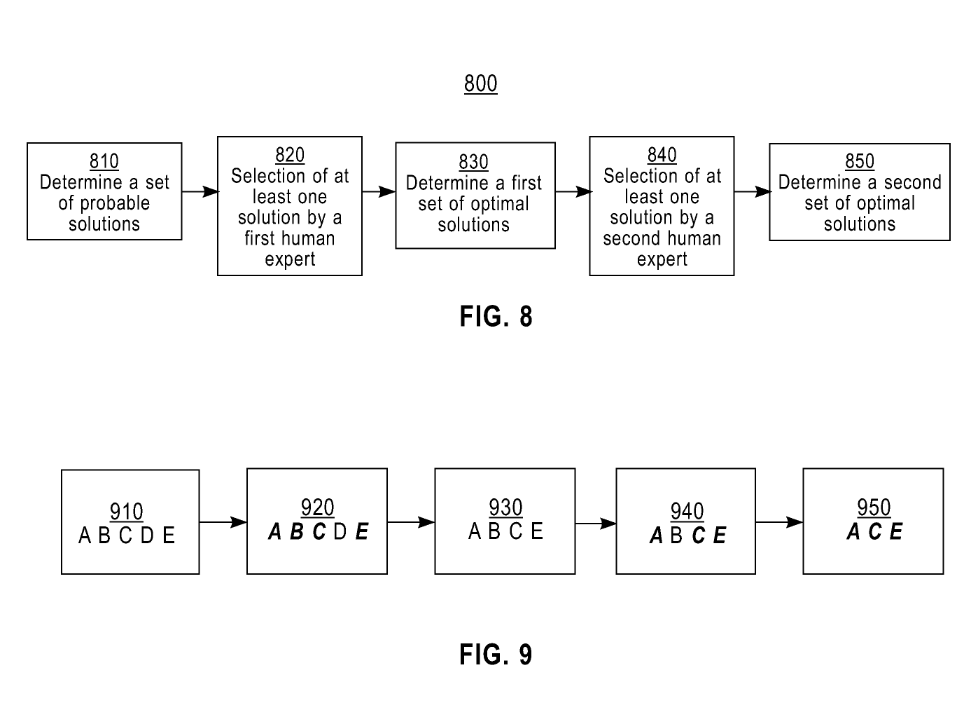

FIG. 8 is a flowchart showing an exemplary method 800 according to a third illustrative embodiment of the present invention. This method begins in step 810 with the determination of a set of probable solutions for a problem. As discussed above in reference to step 110 shown in FIG. 1, this step of determining a set of probable solutions may comprise, for example, automated mining of problem ticket records, accessing a repository of stored solutions, and/or manual entry of one or more probable solutions. Step 820 comprises presenting the set of probable solutions determined in step 810 to at least a first human expert and receiving at least one selection by the at least a first human expert of at least one solution from the set of probable solutions. As discussed above in reference to step 120 shown in FIG. 1, this selection could be as simple as a human expert designating at least one solution from the set of probable solutions or could also include assigning solutions a numeric value, such as an ordinal ranking (e.g., first choice, second choice, third choice) or a cardinal score (e.g., a scale of 1-10, with 1 being most optimal and 10 being least optimal).

Step 830 comprises determining a first set of optimal solutions from the set of probable solutions based at least in part on the at least one selection by the first human expert received in step 820. As will discussed in greater detail hereinafter, this step could comprise, for example, removing at least a portion of the probable solutions not selected by the first human expert from the set of probable solutions and/or re-ordering at least a portion of the set of probable solutions.

Step 840 comprises presenting the first set of optimal solutions determined in step 830 to at least a second human expert and receiving at least one selection by the at least second human expert of at least one solution from the first set of optimal solutions. Again, this selection could be as simple as a second human expert designating at least one solution from the first set of optimal solutions or could also include assigning solutions a numeric value, such as an ordinal ranking (e.g., first choice, second choice, third choice) or a cardinal score (e.g., a scale of 1-10, with 1 being most optimal and 10 being least optimal).

Step 850 comprises determining a second set of optimal solutions from the first set of optimal solutions determined in step 830 based at least in part on the at least one selection by the at least second human expert received in step 840. As will discussed in greater detail hereinafter, this step could comprise, for example, removing at least a portion of the probable solutions not selected by the second human expert from the set of probable solutions and/or re-ordering at least a portion of the set of probable solutions. As discussed above with reference to step 130 shown in FIG. 1, this step may optionally comprise storing the set of optimal solutions in a repository which may, for example, comprise a local repository. Alternatively or additionally, at least a portion of the set of optimal solutions may be stored within the ticket records themselves. In a preferred embodiment, these stored solutions may be used as a set of probable solutions in a subsequent iteration of the method described above.

The technique shown in FIG. 8 advantageously permits an expert to provide selections from the set of probable solutions using another expert's selections. For example, the solutions not selected by the first expert may be removed before the second expert selects solutions, thereby reducing the number of solutions the second expert needs to consider. Each of these selections may play a part in the determination of the set of optimal solutions. For example, the set of optimal solutions may comprise only those solutions selected by all of the human experts.

FIG. 9 shows an exemplary solution set during each step of an illustrative embodiment of the method 800 shown in FIG. 8. Specifically, block 910 shows an exemplary set of probable solutions, corresponding to a possible output of step 810 shown in FIG. 8. Block 920 shows exemplary selections by a first human expert of solutions within the set of probable solutions shown in block 910, corresponding to a possible output of step 820 shown in FIG. 8. In this exemplary embodiment, the first human expert has selected solutions A, B, C and E from the set of probable solutions. The selected solutions are indicated through the use of a bold italic font.

Block 930 shows an exemplary first set of optimal solutions, corresponding to a possible output of step 830 shown in FIG. 8. In this exemplary embodiment, solution D, which was not selected by the first human expert, has been removed from the set of probable solutions. Thus, in this exemplary embodiment, the first set of optimal solutions consists of the solutions which were selected by the first human expert, namely solutions A, B, C and E.

Block 940 shows exemplary selections by a second human expert of solutions within the first set of optimal solutions shown in block 930, corresponding to a possible output of step 840 shown in FIG. 8. In this exemplary embodiment, the second human expert has selected solutions A, C and E from the set of probable solutions. The selected solutions are indicated through the use of a bold italic font.

Block 950 shows an exemplary second set of optimal solutions, corresponding to a possible output of step 850 shown in FIG. 8. In this exemplary embodiment, solution B, which was not selected by the second human expert, has been removed from the set of probable solutions. Thus, in this exemplary embodiment, the second set of optimal solutions consists of the solutions which were selected by both the first and the second human expert, namely solutions A, C and E.

As discussed above with reference to step 130 shown in FIG. 1, this step may optionally comprise storing the set of optimal solutions in a repository which may, for example, comprise a local repository. Alternatively or additionally, at least a portion of the set of optimal solutions may be stored within the ticket records themselves. In a preferred embodiment, these stored solutions may be used as a set of probable solutions in a subsequent iteration of the method described above.

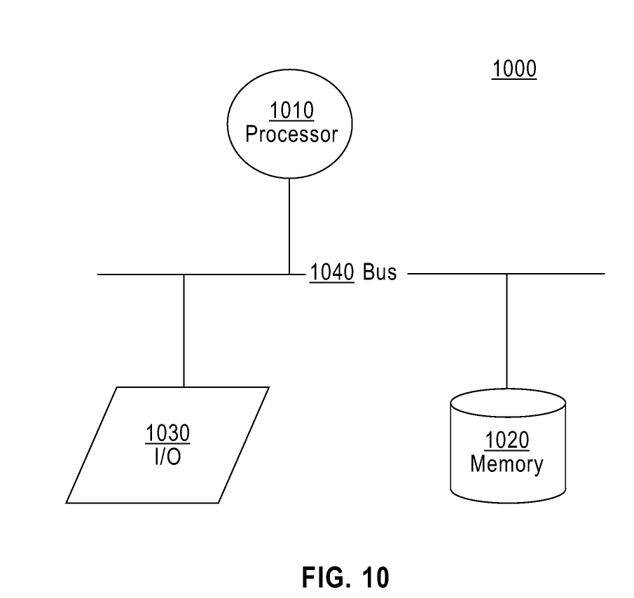

The methodologies of embodiments of the invention may be particularly well-suited for use in an electronic device or alternative system. For example, FIG. 10 is a block diagram depicting an exemplary processing system 1000 formed in accordance with an aspect of the invention. System 1000 may include a processor 1010, memory 1020 coupled to the processor (e.g., via a bus 1040 or alternative connection means), as well as input/output (I/O) circuitry 1030 operative to interface with the processor. The processor 1010 may be configured to perform at least a portion of the methodologies of the present invention, illustrative embodiments of which are shown in the above figures and described herein.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices. The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

Accordingly, an application program, or software components thereof, including instructions or code for performing the methodologies of the invention, as described herein, may be stored in one or more of the associated storage media (e.g., ROM, fixed or removable storage) and, when ready to be utilized, loaded in whole or in part (e.g., into RAM) and executed by the processor 1010. In any case, it is to be appreciated that at least a portion of the components shown in the above figures may be implemented in various forms of hardware, software, or combinations thereof, e.g., one or more DSPs with associated memory, application-specific integrated circuit(s), functional circuitry, one or more operatively programmed general purpose digital computers with associated memory, etc. Given the teachings of the invention provided herein, one of ordinary skill in the art will be able to contemplate other implementations of the components of the invention.

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

What is claimed is:

1. A method of determining a set of optimal solutions for a problem, the method comprising the steps of:
determining a set of probable solutions for the problem;
presenting the set of probable solutions to at least one human expert;
receiving at least one selection by the at least one human expert of at least one solution from the set of probable solutions; and
determining a set of optimal solutions from the set of probable solutions based at least in part on the at least one selection by the at least one human expert.

2. The method of claim 1, wherein the at least one selection further comprises at least one numerical value assigned to the at least one solution by the at least one human expert.

3. The method of claim 2, wherein the at least one numerical value comprises at least one ordinal ranking.

4. The method of claim 2, wherein the at least one numerical value comprises at least one cardinal score.

5. The method of claim 1, further comprising the step of:
storing at least a portion of the set of optimal solutions for the problem in a repository.

6. The method of claim 5, wherein the set of probable solutions for the problem is determined based at least in part on at least a portion of the stored solutions for the problem.

7. The method of claim 1, further comprising the steps of:
presenting at least one of the set of probable solutions and the set of optimal solutions to at least another human expert;
permitting the at least another human expert to select at least one solution from at least one of the set of probable solutions and the set of optimal solutions; and
determining a set of optimal solutions from the set of probable solutions based at least in part on the at least one selection by the at least one human expert and the at least one selection by the at least another human expert.

8. The method of claim 1, wherein the step of determining a set of optimal solutions from the set of probable solutions comprises removing at least a portion of the probable solutions not selected by the at least one human expert from the set of probable solutions.

9. The method of claim 1, wherein the step of determining a set of optimal solutions from the set of probable solutions comprises re-ordering at least a portion of the set of probable solutions.

10. The method of claim 1, wherein the step of determining a set of probable solutions for the problem comprises using at least one categorized probe.

11. The method of claim 1, wherein the step of determining a set of probable solutions for the problem comprises extracting at least one key phrase from at least one of at least one solution and the problem.

12. An apparatus for determining a set of optimal solutions for a problem, the apparatus comprising:
a memory; and
a processor coupled to the memory and operative to perform the operations of:
determining a set of probable solutions for the problem;
presenting the set of probable solutions to at least one human expert;
receiving at least one selection by the at least one human expert of at least one solution from the set of probable solutions; and
determining a set of optimal solutions from the set of probable solutions based at least in part on the at least one selection by the at least one human expert.

13. The apparatus of claim 12, wherein the at least one selection further comprises at least one numerical value assigned to the at least one solution by the at least one human expert.

14. The apparatus of claim 12, wherein the processor is further operative to perform the operation of:
storing at least a portion of the set of optimal solutions for the problem in a repository.

15. The apparatus of claim 14, wherein the set of probable solutions for the problem is determined based at least in part on at least a portion of the stored solutions for the problem.

16. The apparatus of claim 12, wherein the processor is further operative to perform the operations of:
presenting at least one of the set of probable solutions and the set of optimal solutions to at least another human expert;
permitting the at least another human expert to select at least one solution from at least one of the set of probable solutions and the set of optimal solutions; and
determining a set of optimal solutions from the set of probable solutions based at least in part on the at least one selection by the at least one human expert and the at least one selection by the at least another human expert.

17. An article of manufacture for determining a set of optimal solutions for a problem, the article comprising a storage medium encoded with one or more software programs that, when executed by a processor, perform the steps of:
determining a set of probable solutions for the problem;
presenting the set of probable solutions to at least one human expert;
receiving at least one selection by the at least one human expert of at least one solution from the set of probable solutions; and
determining a set of optimal solutions from the set of probable solutions based at least in part on the at least one selection by the at least one human expert.

18. The article of claim 17, wherein the at least one selection further comprises at least one numerical value assigned to the at least one solution by the at least one human expert.

19. The article of claim 17, wherein the one or more software programs perform the further step of:
storing at least a portion of the set of optimal solutions for the problem in a repository.

20. The article of claim 19, wherein the set of probable solutions for the problem is determined based at least in part on at least a portion of the stored solutions for the problem.

21. The article of claim 17, wherein the processor is further operative to perform the operations of:
presenting at least one of the set of probable solutions and the set of optimal solutions to at least another human expert;
permitting the at least another human expert to select at least one solution from at least one of the set of probable solutions and the set of optimal solutions; and
determining a set of optimal solutions from the set of probable solutions based at least in part on the at least one selection by the at least one human expert and the at least one selection by the at least another human expert.
